(19) United States
(12) Patent Application Publication
(10) Pub. No.: US 2020/0270181 A1
(43) Pub. Date: Aug. 27, 2020

(54) MULTI-COMPONENT MORTAR SYSTEM IN A MIXING BAG

(71) Applicant: SIKA TECHNOLOGY AG, Baar (CH)

(72) Inventors: Mohamed CADER, Cranford, NJ (US); Camille LANNEVERE, Jersey City, NJ (US); Maxime LIARD, Zurich (CH); Didier LOOTENS, Küssnacht (CH)

(73) Assignee: SIKA TECHNOLOGY AG, Baar (CH)

(21) Appl. No.: 16/493,086

(22) PCT Filed: Apr. 12, 2018
(86) PCT No.: PCT/EP2018/059395

§ 371 Date: Sep. 11, 2019

(30) Foreign Application Priority Data
Apr. 12, 2017 (EP) 17166317.2

(51) Int. Cl. C04B 40/06; C04B 28/04; C04B 28/06; C04B 28/16

(52) U.S. Cl. CPC C04B 40/065; C04B 28/04; C04B 2111/72; C04B 28/16; C04B 28/06

(57) ABSTRACT

A ready-to-use multi-component mortar system in a mixing bag including a component A which is solid and comprises cement and/or aluminium silicate, and a component B which is an aqueous solution, emulsion or suspension, wherein the mixing bag is a flexible bag including at least two separate sealed chambers which are isolated from each other by a removable or frangible seal and the components A and B of the multi-component mortar system are separately situated in the separate sealed chambers of the mixing bag without any contact to each other.

### TECHNICAL FIELD

The invention relates to a multi-component mortar system, its packaging, mixing and use for repair and refurbishment.

### BACKGROUND OF THE INVENTION

Cementitious mortars typically contain cement and sand and are mixed with water to produce a solid structure after hardening. In ready-mix mortar plants weighing and mixing is usually performed automatically in large scale. However, most of the mortar application is done in smaller batch size. When using ready-mix mortars, which are commonly supplied in bags of about 20 to 25 kg weight, mixing is usually done by transferring the full content of the bag into a mortar mixer or large bucket, adding water and mechanically mixing until the mortar is homogeneous. For smaller batches the desired amount of dry mortar is transferred into a bucket, water is added in adequate amount and the mortar is mixed mechanically with a mixing paddle. Mechanically mixing may however introduce an undesired amount of air into the mortar, which reduces the strength of the hardened mortar. For even smaller batches, mixing is usually done by hand with a spatula, but manually mixing often results in poor homogeneity with lumps in the wet mortar.

Mixing mortar in open buckets or mixers has a big disadvantage. The dry cement and other powdery ingredients can form a corrosive dust, polluting the surroundings and leading to health problems when inhaled. In addition there is the risk of splashing of the alkaline mortar, which can harm people's skin or eyes. Further, some multi-component mortars contain alkaline accelerators or reactive components such as epoxides and amines. Such chemicals can be harmful when they get in contact with skin or eyes.

Additionally, manual addition of water bears the risk of wrong dosage. Too much water in the mortar may cause bleeding and/or segregation of the fresh mortar and reduces the strength of the hardened mortar.

Multi-component mortar systems with pre-weighed dry and aqueous components prevent wrong dosage but not the formation of corrosive dust. If only part of the packed material is needed, proper proportioning of the components is often difficult and accurate mixing equipment is often not at hand, especially for small scale repair work or do-it-yourself applications. In the datasheets of commercial multi-component mortar systems, however, mechanical mixing is strongly recommended.

Mortars provided in flexible bags are commercially available. For their application, the correct amount of water must be added and the mortar can be mixed in the bag. This can prevent splashing of the fresh mortar during mixing but there is still the risk of corrosive dust which forms when the bag is opened for adding the water.

Multi-chamber mixing bags for mixing two or more fluids are known, for example from two-component adhesives based on epoxies or silicones. Such mixing bags, equipped with clamping fixtures or other means to separate the chambers, are described for example in CH 582101, DE 2649772 or DE 19545120.

US 2016/0106519 describes the use of a mixing bag for storing and mixing powder and liquid material for dental use. The powder is an organic polymer of 35 μm particle size in maximum and the liquid is a radically polymerizable monomer. However, homogeneous and fast mixing of powders with liquid, especially mixing reactive inorganic powders like cement with aqueous solutions, is much more difficult than the mixing of two or more liquid materials or of organic liquids with organic powders. Especially, the homogeneous mixing of mortars containing reactive cement and sand with particle size of up to 4 mm, usually needs special mixing equipment.

There is a need for a ready-to use mortar in small package size that can be handled and stored safely and mixed easily without mechanical mixer and has good fresh and hardened properties.

### SUMMARY OF THE INVENTION

It is therefore task of the present invention to provide a safe and easy to use multi-component mortar system in prepacked, small size without the risk of corrosive dust for its user.

It was surprisingly found that this task can be fulfilled by the ready-to-use multi-component mortar system in a mixing bag as described in claim 1.

All components of the mortar system are packed in separate, tightly sealed chambers. They are pre-weighed in correct proportions and therefore ready for mixing.

The removable or frangible seal between the chambers can be removed or can be ruptured manually without destroying the outer walls of the mixing bag. This is very advantageous, as there is no risk for user and environment caused by corrosive dust or released chemicals.

The mortar system of the present invention can be mixed easily and homogeneously in the mixing bag without using any mixing tools such as spatula, mixing machines or the like, just by squeezing and shaking the mixing bag after having removed or ruptured the seal between the chambers. This is very surprising and unexpected since reactive powders often tend to agglomerate or form lumps when contacted with water if they are not mixed thoroughly with special mixing equipment. In addition, it could not be expected that the mixing of a rather coarse mortar typically comprising particles with a particle size of up to 250 μm and more, in a mixing bag is easy and homogeneous without destroying the outer walls of the bag.

The present invention is therefore advantageous with respect to easiness of use and safety of handling of a mortar.

In addition, mixing of the mortar in the bag does not entrain undesired air. A too high content of air in a mortar results in reduced strength of the hardened mortar which is highly undesired.

The multi-component mortar system of the present invention is particularly suitable for repair and refurbishment. With the components A and B pre-weighed and ready for mixing in the bag without mixing tool, it is particularly easy to use and perfectly suited for applications in places where water, measuring tools or mixing equipment is missing or not easily available. This ready-to-use, storage stable repair mortar is also perfectly suited for small scale repair and especially for the do-it-yourself market.

Further aspects of the invention are subject of further independent claims. Specially preferred embodiments are subject of the dependent claims.

### DETAILED DESCRIPTION OF THE INVENTION

Subject of the invention is a ready-to-use multi-component mortar system in a mixing bag comprising
a component A which is solid and comprises cement and/or aluminium silicate, and
a component B which is an aqueous solution, emulsion or suspension, wherein the mixing bag is a flexible bag comprising at least two separate sealed chambers which are isolated from each other by a removable or frangible seal and the components A and B of the multi-component mortar system are separately situated in the separate sealed chambers of the mixing bag without contact to each other.

In the present document the term “mortar” means an aqueous dispersion comprising at least one cement or aluminium silicate, which is able to form a hardened body after the hydration reaction of the cement with water and/or after the reaction of the aluminium silicate with an alkali silicate, as well as the hardened body itself.

The term “multi-component mortar system” refers to a system consisting of two or more components, which are all storage stable when stored separately and form a fresh mortar when mixed, which forms a hardened body upon setting. The term “fresh mortar” refers to a mortar obtained by mixing the components of the multi component mortar system immediately after mixing.

The term “aqueous solution” refers to a liquid component that contains water and at least one material that is dissolved in the water. Plain water, for example water that is used for the preparation of mortars, is not an aqueous solution in the scope of this document.

The term “aqueous emulsion” refers to a mixture comprising water and one or more liquid that is normally not miscible with the water.

The term “aqueous suspension” refers to a mixture comprising water and a fine solid material, not soluble in the water.

The term “solid” refers to a physical state of a material that is neither a gas nor a liquid and which does not contain water or an organic solvent.

The term “calcium aluminate cement” refers to cement with an Al₂O₃ concentration in the range of 30 to 80 weight-%.

Component A of the multi-component mortar system is a solid, preferably in form of a powder and/or granular material, comprising cement and/or aluminium silicate.

Basically, all cements can be used. The cement used may be any available cement type or a mixture of two or more cement types, for example the cements classified under DIN EN 197-1: Portland cement (CEM I), Portland composite cement (CEM II), blast furnace slag cement (CEM III), pozzolanic cement (CEM IV) and composite cement (CEM V). These main types are subdivided into sub-classes which are immediately familiar to the person skilled in the art. Cements which are produced according to an alternative standard, for example ASTM C150 for Portland cement types or ASTM C595 for blended hydraulic cements as well as other national standards like the Indian standard, are equally suitable.

Suitable in particular are CEM I Portland cements according to DIN EN 197, as for example Portland cement type I-42.5, I-42.5 R or I-52.5 or Portland cements according to ASTM C150.

Another kind of cement that is preferably used is calcium aluminate cement, optionally in combination with calcium sulfate and/or Portland cement. Calcium aluminate cement and its combination with Portland cement and optionally calcium sulfate, feature short setting time and high early strength.

The total amount of cement in component A and component B is preferably in such a range to provide about 15 to 45, more preferred 17 to 35 weight-% cement in the fresh mortar. Preferably, the amount of cement in component A is in the range from 20 to 55 weight-%. Such a content of cement guarantees a good final strength of the hardened mortar.

Component A may comprise aluminium silicate. Aluminium silicate does not harden with an aqueous solution, emulsion or suspension in absence of a substance that can react with aluminium silicate. If component A comprises aluminium silicate and no further reactive substance, especially no cement or solid alkali silicate, component B preferably comprises alkali silicate. The aluminium silicate comprised in component A is preferably clay, calcined clay, fly ash, slag, aluminium slag, zeolite, feldspar or mixes thereof.

Preferably, component A and/or B comprise calcium aluminate cement. In combinations of Portland cement with calcium aluminate cement the ratio of the two cements is preferably from 1:10 to 10:1, preferably 1:5 to 5:1, more preferred 1:3 to 3:1, by weight.

If calcium aluminate cement is part of component A or component B in the mortar system, component A preferably contains calcium sulfate. The calcium sulfate is preferably a fine powder and may be used in the form of anhydrite, dihydrate, hemihydrate, or a mixture thereof. The amount of calcium sulfate with respect to calcium aluminate cement is preferably in the ratio of from 1:1 to 1:5 by weight.

Component A comprises preferably from 5 to 55 weight-% Portland cement, from 0 to 25 weight-% calcium aluminate cement and from 0 to 20 weight-% calcium sulfate.

The solid component A preferably comprises sand. Sand is a naturally occurring granular material composed of finely divided rock or mineral particles. It is available in various forms and sizes. Examples of suitable sand are quartz sand, limestone sand, river sand or crushed aggregates. Preferably, at least part of the sand is quartz sand or limestone sand or a mixture thereof, especially preferred is quartz sand, since it is chemically inert, strong, available in various sizes and the workability of the composition can be set advantageously.

Commonly, sand is supplied in different fractions of grains passing through a sieve with clear openings. Preferred is sand of which at least 95 weight-% are smaller than 5 mm, more preferred smaller than 4 mm, even more preferred smaller than 3.5 mm. Large particles in component A may lead to improper mixing and/or may break the bag during mixing.

Preferably, at least part of the sand has a particle size of at least 100 μm, more preferred above 200 μm. Such granulometry enables an optimized grain size distribution for homogeneous mixing, good rheology of the fresh mortar and high strength of the hardened mortar.

Preferred sand has a size from 0.04 to 5 mm, more preferred from 0.05 to 4 mm and even more preferred from 0.05 to 3.5 mm.

Component A comprises preferably from 30 to 70 weight-% of sand.

Component A may further contain mineral filler. The term “mineral filler” refers to a powdery or small sized inorganic material different from cement with a size typically of below 0.5 mm. The type of mineral filler is not limited. It may be an inert material or a latent hydraulic binder. The mineral filler is preferably selected from materials of the group consisting of calcium carbonate, dolomite, titanium dioxide, silica fume, fly ash, slag and mixtures thereof. Preferred fillers are calcium carbonate and silica fume. Component A comprises preferably from 0 to 40 weight-% of mineral filler.

Preferably, component A comprises sand and mineral filler in such an amount to provide about 45 to 75 weight-% of sand and mineral filler in the fresh mortar. Such an amount of sand and filler is of advantage with respect to cost and workability of the mortar.

The start of the hydration of cement is usually delayed for minutes to hours from the mixing of the mortar. For many applications, however, a fast strength development is necessary. Therefore, an accelerator is preferably used for the mortar system.

An accelerator is a substance that reduces the time from mixing to the start of the hydration reaction of cement and/or accelerates the hydration reaction itself. Suitable accelerators for the present mortar system are preferably selected from the group consisting of nitrites, nitrates, chlorides, sulphates, carbonates, fluorides, oxides and hydroxides of alkali or earth alkali metals, organic amines, especially hydroxyalkyl amines, and mixtures or combinations thereof.

Component A preferably comprises at least one accelerator.

The accelerator is preferably selected from the group consisting of alkali hydroxide, earth alkali hydroxide, alkali oxide, earth alkali oxide, lithium carbonate, lithium sulfate and organic amine. Most preferably, the accelerator is selected from the group consisting of sodium hydroxide, lithium hydroxide, calcium hydroxide, calcium oxide, lithium sulfate, lithium carbonate and hydroxyalkyl amine.

The accelerator speeds up the strength development of the fresh mortar which is desirable, especially for repair applications which demand a high early strength, for example road patching work.

Component A may contain further additives. Such additives are preferably selected from dispersing agents, plasticizers, superplasticizers, retarders, stabilizers, shrinkage reducers, air detraining agents, thickeners, light weight aggregates, fibres, colouring agents and chromate reducing agents.

A preferred component A, especially suitable in combination with component B1, described later, contains

from 15 to 25 weight-% Portland cement,
from 5 to 20 weight-% calcium aluminate cement,
from 1 to 5 weight-% calcium sulfate,
from 30 to 50 weight-% sand,
from 20 to 40 weight-% mineral filler,
from 0.1 to 1.0 weight-% accelerator and
from 0 to 5 weight-% additives.

A preferred component A, especially suitable in combination with component B2, described later, contains

from 20 to 55 weight-% Portland cement,
from 30 to 60 weight-% sand,
from 0 to 20 weight-% mineral filler
from 0.1 to 3 weight-% accelerator and
from 0 to 5 weight-% additives.

A further preferred component A, especially suitable in combination with component B3, described later, contains

from 20 to 45 weight-% Portland cement,
from 0 to 10 weight-% calcium aluminate cement,
from 0 to 10 weight-% gypsum,
from 50 to 70 weight-% sand,
from 0 to 30 weight-% mineral filler,
from 0 to 5 weight-% amine hardener for epoxy and
from 0 to 5 weight-% additives.

Component B of the multi-component mortar system is an aqueous solution, emulsion or suspension. Component B is not plain water. Especially component B is not water as typically used for the production of concrete or mortar.

If component B contains only water, the performance of the ready-to-use mortar system is inferior to mortars containing a component B, especially a component B1, B2, B3 or B4, of this invention, as is shown in the examples. Preferably, component B is an aqueous emulsion or suspension, thus it contains besides water at least one liquid or solid material that is not soluble in water.

Preferably from 5 to 65 weight-%, more preferably from 7 to 65 weight-%, even more preferably from 10 to 65 weight-% of the material comprised in component B is not soluble in water.

The liquid or solid material in component B alone or after reaction with material comprised in component A or component C, described later, improves the properties of the fresh and/or hardened mortar.

Unexpectedly, besides of its positive effect on the mortar properties, a component B having either a surface tension of 30 to 45 mN/m, more preferred from 35 to 40 mN/m and/or a viscosity in the range of 15 to 2,000 Pa·s, preferably 100 to 1,500 Pa·s, more preferably 100 to 1,000 Pa·s, at a shear rate of 1 s⁻¹ at 23° C., can be mixed faster and more homogeneously with component A than pure water. Component B with lower surface tension may lead to undesired air entrainment in the mortar even if mixed in the bag and higher surface tension has reduced effect on the mixing. Higher viscosity of component B reduces the ease of mixing.

Therefore, component B of the mortar system preferably has a surface tension from 30 to 45 mN/m, more preferred from 35 to 40 mN/m, measured at 23° C. with the Wilhelmy plate method, and/or a viscosity in the range of 15 to 2,000 Pas, preferably 50 to 1,500 Pas, more preferably 100 to 1,000 Pas, at a shear rate of 1 s⁻¹, measured at 23° C. with the plate-plate rheometer Physica MCR 301, Anton Paar, Austria and the Software Rheoplus, with a plate diameter of 25 mm and 2 mm gap.

In a preferred embodiment component B is selected from the group consisting of
component B1, which is an aqueous suspension comprising a water-insoluble organic polymer,
component B2, which is an aqueous suspension comprising a set-inhibited calcium aluminate cement,
component B3, which is an aqueous emulsion comprising an epoxy resin, and
component B4, which is an aqueous solution, emulsion or suspension comprising an alkali silicate.

Component B may contain further additives. Such additives are preferably selected from surfactants, dispersing agents, plasticizers, superplasticizers, retarders, stabilizers, shrinkage reducers, air detraining agents, thickeners, accelerators, colouring agents, and biocides.

In one aspect of the present invention, component B is an aqueous suspension B1 comprising a water-insoluble polymer. Suspensions of water-insoluble polymers are obtainable by free-radical polymerization of unsaturated water-insoluble monomers in aqueous medium in the presence of surfactants.

The water-insoluble polymer of component B1 preferably has a “minimum film forming temperature” (MFT) of 25° C. or below, more preferably of 19° C. or below. That means, such a polymer is able to form a film by self-coalescence at and above its MFT. A low MFT is of special advantage for outdoor applications of the mortar system in cold conditions.

Examples of such water-insoluble polymers with low MFT are polymers comprising styrene, ethylene, butadiene, acrylic esters, vinylidene chloride, vinyl chloride or vinyl acetate.

Preferably, the water-insoluble polymer comprised in component B1 is selected from the group consisting of homo- or copolymers of acrylic esters, copolymers of styrene and butadiene, copolymers of styrene with acrylic esters, and homo- or copolymers of vinyl acetate. Most preferred are pure acrylic polymers or styrene-acrylate copolymers.

Aqueous suspensions of such polymers are commercially available with a polymer content of about 40 to 60 weight-%. They are sold, for example, under the trade names Acronal® (BASF), Primal™ (DOW) or Revacryl (Synthomer).

Preferably, component B1 contains such an amount of water-insoluble polymer to provide at least 1 weight-%, more preferably from 1 to 5 weight-%, even more preferably from 1 to 3 weight-%, of the water-insoluble polymer in the fresh mortar. Such an amount is optimal with regard to costs and performance. A preferred composition of component B1 contains from 8 to 20 weight-% water-insoluble polymer, from about 80 to 91 weight-% water and from 0.05 to 5 weight-% further additives.

Such component B1, besides enabling a fast and homogeneous mixing with component A, which is highly desired, can additionally improve adhesion, durability, chemical resistance and flexural strength of the hardened mortar.

In another aspect of the present invention, component B is an aqueous suspension B2 comprising an aqueous suspension of a set-inhibited calcium aluminate cement.

Calcium aluminate cement reacts with water in a complex hydration reaction forming calcium aluminate hydrates. This reaction of the cement with water forming a hardened body is called setting of the cement.

Suitable calcium aluminate cements comprise 30-80 weight-% Al₂O₃ and are commercially available, for example from Kerneos, France, under the tradenames Ternal®, for example Ternal® White or Ternal® RG; or Secar®, for example Secar® 51; or Ciment Fondu®.

The set inhibitor inhibits the setting reaction of the calcium aluminate cement in component B2 enabling a good storage stability of component B2. The set inhibitor is preferably selected from phosphorous compounds such as phosphoric acid, metaphosphoric acid, phosphorous acid, phosphonic acids, aminoalkyl phosphonic acids and phosphono alkyl carboxylic acids, or mixtures thereof. Optionally, the set inhibitor may further contain additional compounds such as carboxylic acids, hydroxy carboxylic acids or amino acids. The phosphate-based set inhibitor provides an excellent long term stability of the set inhibited calcium aluminate cement slurry. Preferably, component B2 comprises such an amount of set inhibitor as to inhibit the hydration of the calcium aluminate cement for at least from 1 month to about 2 years, more preferred from 2 months to 1 year, even more preferred from 3 months to 1 year at 10 to 50° C. Such slurries can be stored during several months up to two years or longer without losing their applicability.

Suitable set-inhibited calcium aluminate cements in the form of aqueous slurries are described in US 2014/0343194. They are commercially available, for example from Kerneos, France, under the brand name Exalt.

When mixed with an alkaline compound, preferably comprised in component A, the set-inhibition is compensated and the calcium aluminate cement produces a fast hardening mortar.

In a specially preferred composition, component B2 contains from 20 to 60 weight-% calcium aluminate cement, from 0.1 to 5 weight-% phosphate based set-inhibitor, from 20 to 60 weight-% calcium carbonate filler, from 0.1 to 5 weight-% admixtures and from about 16 to 25 weight-% water.

Preferably, component B2 contains such an amount of calcium aluminate cement to provide, together with the calcium aluminate cement optionally comprised in component A, from 10 to 25 weight-%, more preferably from 15 to 22 weight-% of calcium aluminate cement per weight of the fresh mortar. Such an amount of calcium aluminate cement results in a fast setting of the mortar without too strong heat development. Too strong heat development may cause cracks and other damages in the hardened mortar.

Preferably, component B2 contains from 20 to 60 weight-% calcium aluminate cement and a phosphor-based set-inhibitor.

Such a component B2 preferably has a viscosity in the range of 15 to 2, 000 Pas, preferably 50 to 1,500 Pas, more preferably 100 to 1,000 Pas, at a shear rate of 1 s⁻¹, measured at 23° C. with the plate-plate rheometer Physica MCR 301, Anton Paar, Austria and the Software Rheoplus, with a plate diameter of 25 mm and 2 mm gap.

Surprisingly, component B2 can be mixed easily and homogeneously with the solid component A in the mixing bag. After mixing with component A, the resulting mortar can be easily applied and hardens fast, which is especially desired for repair and refurbishment applications.

In another aspect of the present invention, component B is a component B3 comprising an epoxy resin.

The epoxy resin is not limited as far as it can be emulsified or dispersed in water and is able to react with amine hardeners.

Preferably the epoxy resin is a so called polyepoxide liquid resin with a glass transition temperature of below 25° C.

Particularly the epoxy resin comprised in component B3 is a liquid resin based on bisphenol-A- or bisphenol-F- or bisphenol-A/F-diglycidyl ether.

The epoxy resin may comprise a reactive diluent, particularly glycidyl ethers of mono- or polyhydric phenols or aliphatic or cycloaliphatic alcohols such as diglycidyl ether of butanediol or hexanediol or polyoxypropyleneglycole or cardanol or monoglycidylether of natural alcohols such as C₈- to C₁₀-, C₁₂- to C₁₄- or C₁₃- to C₁₅-alkylglycidylether.

To enable a stable aqueous emulsion of the epoxy resin, component B3 comprises preferably at least one emulsifier, more particularly a nonionic emulsifier.

Commercial epoxy resin emulsions are particularly suitable as component B3 or as part of component B3, such as Sika® Repair/Sikafloor® EpoCem® Modul A (from Sika) or epoxy resin emusions from companies such as Huntsman, Dow or Momentive.

Component B3 may contain further additives, for example reactive or non-reactive diluents, fillers, pigments, dispersing agents, defoamers or thickeners.

Component B3 has preferably a water content of 30 to 80 weight-%.

The concentration of the epoxy resin comprised in component B3 is preferably adapted to provide from 0.5 to 4, more preferred from 0.6 to 3 weight-% of epoxy resin in the fresh mortar.

Preferably component B3 comprises from 15 to 65 weight-% of a liquid epoxy resin.

In the case of a component B3 comprising an epoxy resin, the mortar system further comprises an amine hardener suitable to react with the epoxy resin. This amine hardener contains preferably at least one di- or polyamine with at least three amine hydrogens. More preferably, the amine hardener is a water dilutable amine mixture containing typically a mixture of di- or polyamines, polyalkylene amines and amine-functional adducts of amines with epoxides. Such an amine hardener may be comprised in component A or is preferably present in form of an additional separately packed component C, which is also part of the mixing bag, in a suitable amount for curing the epoxy resin.

A mortar system containing an epoxy resin and hardener can be applied on damp surfaces and enables good adhesion properties. Additionally, it can be coated with an epoxy- or PU-based coating within short time after application, usually already after 2 to 7 days, which is advantageous, since it saves time. In addition, such mortars have generally better adhesion properties, better chemical resistance and provide a better barrier against water vapour compared to mortars without epoxy material.

In the case of component A comprising aluminium silicate, component B is preferably a component B4 comprising alkali silicate. After mixing such a component A with component B4, the aluminium silicate and the alkali silicate react forming a three-dimensional inorganic polymer structure, eventually forming a solid material.

The ratios of component A to component B and optional further components depend on the composition of the components.

The ratio of the components and the concentration of the components are preferably adapted in such a way to provide a W/C (total weight of water divided by total weight of the cement) of 0.25 to 0.65, more preferably from 0.38 to 0.62 after mixing of the components. Such a W/C ensures good fresh and hardened properties of the mortar.

In the present invention, the multi-component mortar system is provided in a mixing bag. The mixing bag is a flexible bag comprising at least two separate sealed chambers which are isolated from each other by a removable or frangible seal and the components A and B of the multi-component mortar are separately situated in the separate sealed chambers of the mixing bag without any contact to each other.

The mixing bag is preferably water- and airtight.

The mixing bag is preferably mainly out of polyethylene, polypropylene, ethylene-propylene copolymer, ethylene-vinylacetate copolymer, ethylene-vinylalcohol copolymer, polyester or polyamide. Preferred are bags of multi-layer films or laminate films. The multi-layer films or laminate films may contain layers of metal, especially out of aluminium, and/or layers containing inorganic filler, for example titanium dioxide. The thickness of the film is not limited as long as it is flexible enough to enable squeezing and kneading of the mortar without breaking. Preferably, the thickness of the film is from 50 to 250 μm, more preferably from 80 to 150 μm Preferably, the bag is formed from a flexible tube.

Also preferred, the bag is formed of two separate layers of rectangular sheets which are thermally welded in the peripheral zones. One or both of the sheets may be laminated, for example with aluminium, to increases the water vapour resistance. The sheets may also be coated and/or printed on the outer side. Preferably, at least part of one side of the mixing bag is transparent. This enables the visual examination of the mixing quality.

The bag is divided into at least two separate chambers by tight, frangible or removable seals.

The removable seal may be a clamp that presses the layers tightly together. The frangible seal may be a pressure lock or a section formed by weak thermal welding.

In case of a frangible seal, it must break when the chamber containing component B is deliberately pressed together with manual force applying pressure on the seal, but it must withstand normal handling of the bag. The strength of the sealing of the peripheral walls must be high enough to withstand the pressure necessary to break the seal between the chambers. Such a mixing bag with frangible seal enables easy handling and a safe mixing of all components contained in the mortar system.

Preferred is therefore a mortar system provided in a mixing bag in which the at least two separate sealed chambers of the mixing bag are isolated from each other by a frangible seal which breaks when the chamber containing component B is pressed together carefully by hand without causing any rupture of the outer walls of the mixing bag.

If a component C is part of the mortar system, a mixing bag with three separate chambers is used. Preferably, the three chambers are in serial arrangement, with a removable or frangible seal between the chambers comprising component A and B and a removable or frangible seal between the chambers comprising component B and C.

Preferred is a mixing bag produced from two rectangular sheets, sealed by a strong thermal welding on the longer peripheral sides, with chambers separated by frangible seals installed across the bag in parallel to the shorter side of the sheets. Such a bag is of advantage, since the production is cheap, the size of the chambers is easily adaptable and the handling is easy.

The size of the bag is only limited by the weight of the mortar system and must not impede easy mixing and handling.

The weight of the mortar system in the mixing bag is preferably from 100 g to 4 kg, more preferably from 300 g to 3 kg and most preferably from 500 g to 2 kg. This weight can easily be handled for mixing and application and is ideally suited for repair and refurbishment in small scale.

To mix the components the seal between the chambers is removed or broken. The breaking of the frangible seal is preferably done by squeezing the chamber containing component B by hand or by carefully rolling up the chamber comprising component B towards the chamber comprising component A. When the seal or the seals between the chambers of the mixing bag are removed or broken, component B and optionally component C, are preferably transferred into the chamber comprising component A. It is advantageous to transfer the liquid component or components into the solid component since this enables better mixing. The components are then mixed either in the chamber of component A or in the newly created combined chamber of the components A and B. The mixing is done by shaking, kneading or squeezing the mixing bag until a homogeneous liquid mortar is formed, preferably during 10 seconds to 2 minutes, more preferably during 10 to 30 seconds. The mortar system enables short mixing time which is user-friendly.

A further object of the present invention is a method of producing a mortar comprising the steps of
providing a mortar system as described above
removing or breaking the seal between the at least two separate sealed chambers containing component A and component B,
combining component B with component A through the leak between the two chambers,
mixing component A and component B by shaking, kneading and/or squeezing the mixing bag thoroughly, preferably during 10 seconds to 2 minutes, more preferably during 10 to 30 seconds.

In the case of a component B3 comprising an epoxy resin and a component C comprising an amine hardener for the epoxy resin, it can be advantageous to first break or open the seal between component B and C, optionally mixing both components, followed by breaking or opening the seal between the chambers of component B and component A and transferring the combined components B and C together into the chamber of component A, where the three components are homogenously mixed.

After combining and mixing of the components the bag is opened and the mixed mortar is pressed out of the bag and applied. The bag may be opened for example by using scissors, knife or other sharp tools. The mortar is either free flowing or can be easily pressed out of the mixing bag.

Preferably, the mortar is free flowing and self-levelling. This is especially advantageous for repair and refurbishment of horizontal surfaces. Another preferred consistency of the fresh mortar is almost self-levelling with only minimal force necessary to smooth the surface. This is especially advantageous for repair and refurbishment of sloping surfaces.

Still another preferred consistency of the fresh mortar is a self-supporting but still easily applicable paste. This is especially advantageous for repair and refurbishment of vertical and overhead surfaces.

The fresh mortar hardens fast. Preferably it reaches a compressive strength of more than 1 MPa 4 hours, more preferably 2 hours, even more preferably 1 hour after the application. Preferably has the mortar a compressive strength of more than 10 MPa, more preferably more than 15 MPa, 24 hours after the application, measured on prisms of 40×40×160 mm size according to EN 196-1.

The fast gain of strength of the mortar system is highly desirable, especially for repair and refurbishment of load bearing structures, especially for road patching, since the repaired structures can be used within short time.

Preferably, the hardened mortar, when applied on a concrete surface, has a bond strength of at least 0.8 MPa, more preferred at least 1.5 MPa after 2 days and at least 2 MPa, more preferred at least 3 MPa after 28 days, measured according to EN 1542.

A further object of the present invention is the use of the described mortar system for repair and/or refurbishment.

### EXAMPLES

The following examples, without being limitative, illustrate the present invention.

1. Measuring Methods The compressive strength of the mortar was measured on prisms of 40×40×160 mm size according to EN 196-1.

The setting time of the mortar was measured with a Gillmore needle according to ASTM C266.

The surface tension was measured with the Wilhelmy plate with Tensiometer K100MK3 from Kruess at 23° C.

The viscosity was measured with a plate-plate rheometer (Physica MCR 301, Anton Paar, Austria; Software Rheoplus) with a plate diameter of 25 mm and 2 mm gap at 23° C.

### 2. Composition of Components A, B and C

### Component A-1

Mixture of 260 g Portland cement (ASTM type I/II), 194 g calcium aluminate cement (comprising about 42 weight-% Al₂O₃), 50 g calcium sulfate anhydrite, 538 g quartz sand 0.1-0.6 mm, 450 g calcium carbonate filler and 3.5 g lithium carbonate.

### Component A-2

Mixture of 256 g Portland cement (ASTM type I/II), 223 g calcium aluminate cement (comprising about 42 weight-% Al₂O₃), 50 g calcium sulfate anhydrite, 526 g quartz sand 0.1-0.6 mm, 440 g calcium carbonate filler and 3.9 g lithium carbonate and 0.4 g tartaric acid.

### Component A-3

Mixture of 278 g Portland cement (ASTM type I/II), 211 g calcium aluminate cement (comprising about 42 weight-% Al₂O₃), 54 g calcium sulfate anhydrite, 518 g quartz sand 0.1-0.6 mm, 435 g calcium carbonate filler and 3.6 g lithium carbonate and 0.4 g tartaric acid.

Component A-4 Mixture of 74.5 g Portland cement (CEM I 42.5), 35.5 g river sand 0-1 mm, 35.5 g river sand 2-4 mm, 3.0 g CaO (fine powder) and 1.5 g dispersing agent (Sika® ViscoCrete® 510P, a polycarboxylate powder).

### Component A-5

Mixture of 332 g Portland cement (CEM I 42.5 R), 625 g quartz sand 0.1-2.2 mm, 10 g shrinkage reducer (based on calcium sulfo aluminate and neopentyl glycol), 21 g calcium carbonate filler and 12 g of further admixtures (fibres, thickener, plasticizer, silica fume and chromate reducing agent).

### Component B1-1

Mixture of 150 g of an aqueous styrene-acrylate polymer suspension with about 50 weight % polymer, 449 g water and 1 g preservative.

The surface tension of component B1-1 was 37.8 mN/m.

### Component B2-1

Mixture of 361 g Exalt, (from Kerneos, France, a white set-inhibited calcium aluminate cement suspension containing about 40 weight-% water and about 58 weight-% calcium aluminate cement with about 67 weight-% Al₂O₃), 361 g calcium carbonate powder (Omyalite® 90, from Omya), 2.8 g lithium carbonate and 25.2 g water.

The viscosity of component B2-1 was 190 Pas, measured at a shear rate of 1 s⁻¹.

### Component B3-1

Sikafloor® EpoCem® Modul A (emulsion of epoxy resin in water, about 38 weight-% water, from Sika).

The surface tension of component B3-1 is 39.8 mN/m.

### Component C-1

Sikafloor® EpoCem® Modul B (emulsion of modified polyamine and water, about 85 weight-% water, from Sika).

### 3. Production of the Mortar System in a Mixing Bag

Mixing bags with two chambers were used. They consist of two rectangular multi-layer sheets thermally welded on the longer sides. Across the bag, in a defined distance parallel to the open sides, a frangible seal is installed forming a bag with two open chambers. Component A was filled in one chamber and the chamber was thermally sealed, then the second chamber was filled with component B which was also thermally sealed.

In mortar systems comprising a component C, the chamber filled with component B is sealed by a frangible seal in such a distance from the opening to fully enclose component B but leaving room for a third chamber which is filled with component C and then sealed.

### Example 1

A mixing bag with two chambers of about 18×18 cm and 18×28 cm, respectively, contained 1500 g of component A-1 in the large chamber and 325 g of component B1-1 in the small chamber.

By rolling and squeezing the end of the chamber containing component B1-1 and applying pressure towards the chamber containing component A1, the frangible seal was broken and component B1-1 was pressed into the chamber containing component A-1. The bag was squeezed, pressed and shaken for about 20 seconds to mix component A-1 with component B1-1.

One side of the bag was opened with scissors and the mortar was pressed out of the bag. The aspect of the mortar was homogeneous without lumps, and it was free flowing and almost self-levelling.

The setting time of the mortar was about 10 minutes and the compressive strength after 24 hours was 19.1 MPa.

### Comparative Example 1

As described in example 1 a mortar in a mixing bag was provided but component B1-1 was fully replaced by water.

The mixing was more difficult and needed more time compared to example 1 and the mortar was a thick paste which did not flow.

### Example 2

In the same way as described in example 1 a mortar of 1500 g component A-2 and 325 g component B1-1 was mixed and applied.

The aspect of the mortar was homogeneous without lumps.

The setting time was about 24 minutes and the compressive strength after 24 hours, was 18.3 MPa.

### Comparative Example 2

1500 g of component A-2 and 325 g of component B1-1 were mixed in a Hobart mixer for 3 minutes.

The aspect of the mortar was homogeneous without lumps.

The setting time was about 30 minutes and the compressive strength, after 24 hours, was 20.2 MPa.

### Example 3

In the same way as described in example 1 a mortar of 1500 g component A-3 and 325 g component B1-1 was produced.

The aspect of the mortar was homogeneous without lumps.

The setting time was about 20 minutes, the compressive strength after 1 hour was 5.5 MPa, after 2 hours 10.7 MPa and after 24 hours 19.2 MPa.

### Example 4

A mixing bag, similar to the bag described in example 1 but with different size of the bag and the chambers, was filled with 150 g component A-4 and 750 g component B2-1. The mortar was mixed as described in example 1. The fresh mortar was homogenous without lumps.

The setting time was about 1 hour and 25 minutes and the strength was 6.3 MPa after 4 hours and 12 MPa after 14 hours.

### Example 5

In a mixing bag comparable to the bag described in example 1 but with 3 chambers of different size in serial sequence, 1295 g component A-5, 70 g component B3-1 and 175 g component C-1 were provided in chambers 1, 2 and 3, respectively. By squeezing the end of the chamber containing component C-1 and applying pressure towards the chamber containing component B3-1, the frangible seal was broken, and component C-1 was premixed with component B3-1 by shaking, squeezing and pressing the combined chambers for 20 to 30 seconds. Next, the bag was rolled up starting from the chamber having contained component C-1 and the mix of component C-1 with component B3-1 was pressed against the frangible seal towards component A-5. After rupture of the seal, the mixed components C-1 and B3-1 were mixed with component A-5 by shaking, squeezing and pressing the mixing bag for about one minute. One side of the bag was opened with scissors and the mortar was pressed out of the bag.

The aspect of the mortar was homogeneous without lumps and it was free flowing and almost self-levelling. The compressive strength after 24 hours was 20.5 MPa and after 28 days 60.1 MPa.

### Comparative Example 3

A commercial repair mortar supplied in a plastic bag sealed with a ziplock, containing 1.36 kg of a dry mortar was used. When the seal was opened to add the recommended 305 g water and during the addition of water, dust came out of the opening. After adding the water, the ziplock was closed again and the bag was shaken to mix the mortar. Even after 3 minutes of heavy shaking and kneading the material was still not homogenous, but contained parts with dry material and lumps.

### DESCRIPTION OF THE DRAWINGS

FIG. 1, FIG. 2 and FIG. 3 show schematic drawings of a flexible mixing bag with two separate sealed chambers. These figures generally illustrate a flexible mixing bag 1 comprising two separate sealed chambers 2, 3 with a frangible seal 6 between the two chambers. Chamber 2 contains the solid component A 4, and chamber 3 contains the aqueous component B5.

FIG. 4 shows a schematic drawing of a flexible mixing bag with three separate sealed chambers and generally illustrates a flexible mixing bag 10 comprising three separate sealed chambers 20, 22, 22 with frangible seals 16 between the chambers. Chamber 20 contains the solid component A4 and the two chambers 22 contain the liquid components B5 and C5.

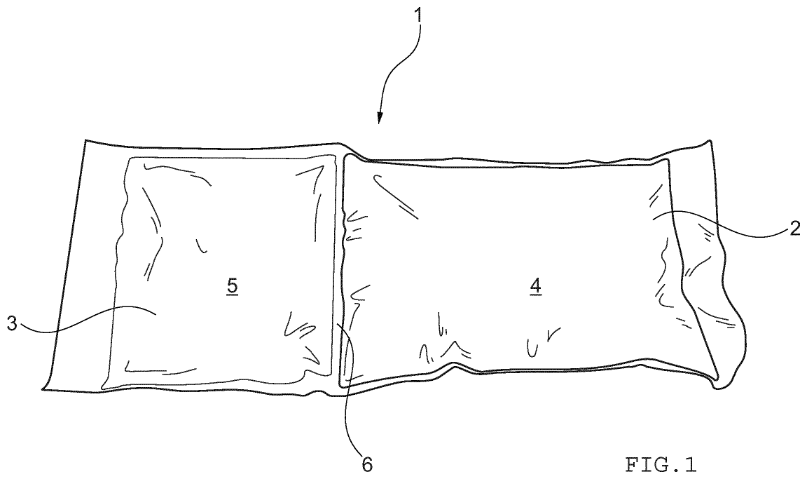

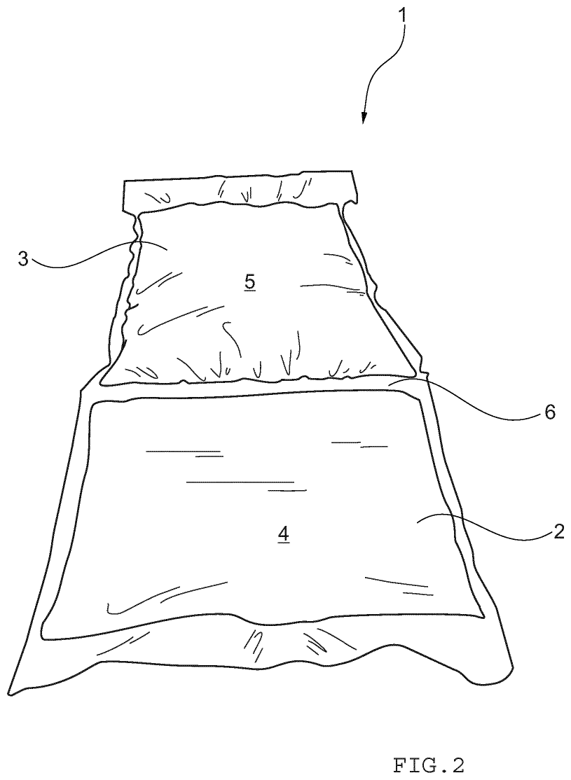

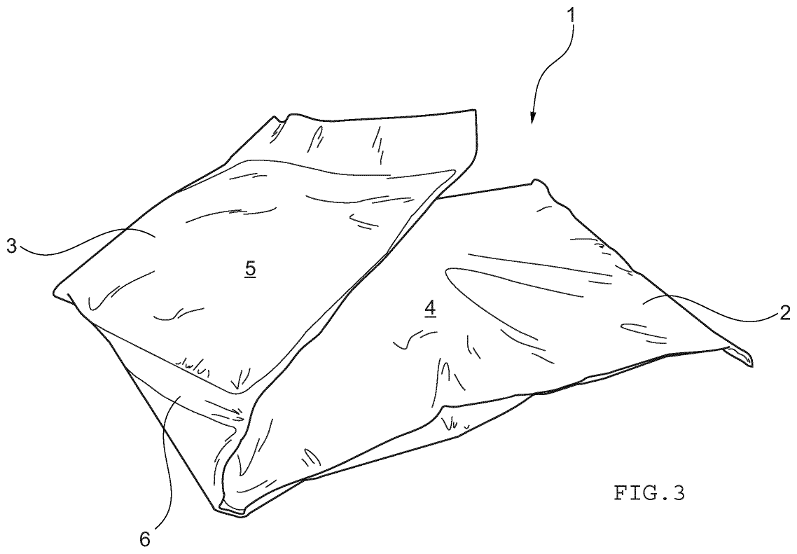

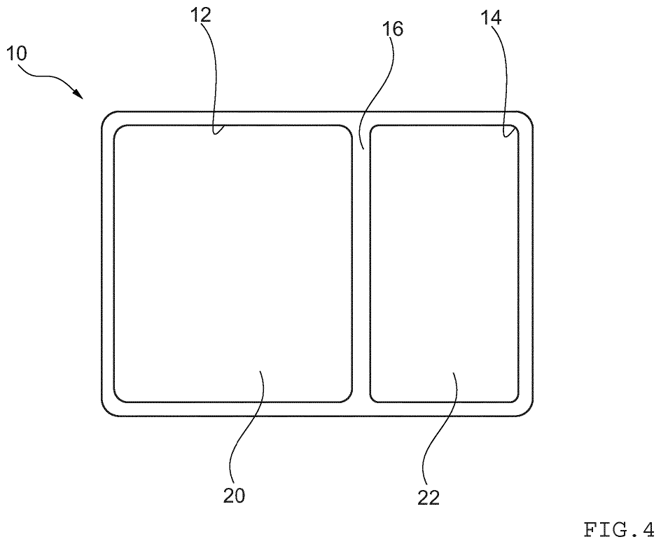

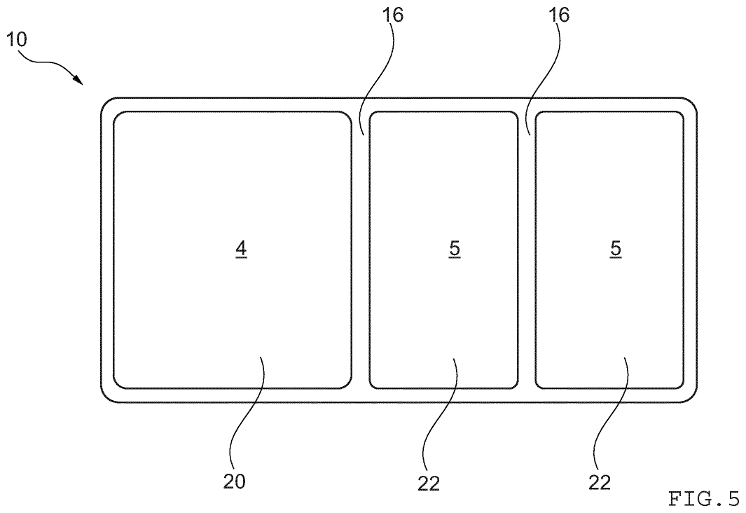

1. A ready-to-use multi-component mortar system in a mixing bag comprising
a component A which is solid and comprises cement and/or aluminium silicate, and
a component B which is an aqueous solution, emulsion or suspension,
wherein the mixing bag is a flexible bag comprising at least two separate sealed chambers which are isolated from each other by a removable or frangible seal and the components A and B of the multi-component mortar system are separately situated in the separate sealed chambers of the mixing bag without contact to each other.

2. The mortar system according to claim 1, wherein component A comprises sand and at least part of the sand has a particle size of at least 100 μm.

3. The mortar system according to claim 1, wherein component A and/or component B comprise calcium aluminate cement.

4. The mortar system according to claim 1, wherein component A comprises at least one accelerator.

5. The mortar system according to claim 4, wherein the accelerator is selected from the group consisting of alkali hydroxide, earth alkali hydroxide, alkali oxide, earth alkali oxide, lithium carbonate, lithium sulfate and organic amine.

6. The mortar system according to claim 1, wherein the surface tension of component B is from 30 to 45 mN/m, measured at 23° C. with the Wilhelmy plate method and/or the viscosity of component B is in the range of 15 to 2,000 Pas, at a shear rate of 1 s⁻¹, measured at 23° C. with the plate-plate rheometer Physica MCR 301, Anton Paar, Austria and the Software Rheoplus, with a plate diameter of 25 mm and 2 mm gap.

7. The mortar system according to claim 1, wherein component B is selected from the group consisting of
component B1, which is an aqueous suspension comprising a water-insoluble organic polymer,
component B2, which is an aqueous suspension comprising a set-inhibited calcium aluminate cement,
component B3, which is an aqueous emulsion comprising an epoxy resin, and
component B4, which is an aqueous solution, emulsion or suspension comprising an alkali silicate.

8. The mortar system according to claim 7, wherein component B is a component B1 wherein the water-insoluble organic polymer is selected from the group consisting of homo- or copolymers of acrylic esters, copolymers of styrene and butadiene, copolymers of styrene with acrylic esters, and homo- or copolymers of vinyl acetate.

9. The mortar system according to claim 7, wherein component B is a component B2 containing from 20 to 60 weight-% calcium aluminate cement and a phosphate-based set-inhibitor.

10. The mortar system according to claim 7, wherein component B is a component B3 wherein the epoxy resin is a liquid resin based on bisphenol-A- or bisphenol-F- or bisphenol-A/F-diglycidyl ether.

11. The mortar system according to any claim 1, wherein the at least two separate sealed chambers of the mixing bag are isolated from each other by a frangible seal, which breaks when the chamber containing component B is pressed together carefully by hand without causing any rupture of the outer walls of the mixing bag.

12. A method of producing a mortar comprising the steps of
providing a mortar system according to claim 1,
removing or breaking the seal between the at least two separate sealed chambers containing component A and component B,
combining component B with component A through the leak between the two chambers,
mixing component A and component B by shaking, kneading and/or squeezing the mixing bag thoroughly.

13. The method according to claim 12, wherein the bag is opened after combining and mixing of the components, the mixed mortar is pressed out of the bag and applied.

14. A method of repairing or refurbishing a product, comprising applying the mortar system according to claim 1 to the product.

15. The mortar applied according to the method of claim 13 with a compressive strength of more than 1 MPa after 4 hours measured according to EN 196-1.
